(19) United States
(12) Patent Application Publication
(10) Pub. No.: US 2026/0340285 A1
(43) Pub. Date: Oct. 29, 2026

(54) TEXT VERIFICATION METHOD AND APPARATUS, STORAGE MEDIUM, AND ELECTRONIC DEVICE

(71) Applicant: Alipay (Hangzhou) Digital Service Technology Co., Ltd., Hangzhou (CN)

(72) Inventors: Anda CHENG, Hangzhou (CN); Qiqi LIN, Hangzhou (CN); Wangqun PAN, Hangzhou (CN); Yinggui WANG, Hangzhou (CN)

(21) Appl. No.: 19/658,398

(22) Filed: Apr. 24, 2026

(30) Foreign Application Priority Data
Apr. 27, 2025 (CN) 202510537482.2

(51) Int. Cl. G06F 40/279

(52) U.S. Cl. CPC G06F 40/279

(57) ABSTRACT

This specification of the present application discloses a text verification method and apparatus, a storage medium, and an electronic device. A to-be-verified text set for constructing a knowledge base is obtained, and a similarity between every two to-be-verified texts in the to-be-verified text set is determined. Each to-be-detected text pair for performing knowledge conflict detection is determined based on each similarity. It is determined, by using a pre-trained knowledge conflict detection model, whether knowledge included in every two to-be-detected texts conflicts. If no, the two to-be-detected texts are reserved. If yes, a plurality of original texts of the two to-be-detected texts including the conflicting knowledge are obtained through a plurality of search engines, and a kept text is determined from the two to-be-detected texts including the conflicting knowledge based on the plurality of original texts. Because attackers cannot modify knowledge in each search engine, multiple original texts of to-be-detected texts are queried through multiple engines, and erroneous texts and kept texts can be determined based on the original texts, preventing the erroneous texts from being stored in a knowledge base.

### TECHNICAL FIELD

This specification of the present application relates to the field of artificial intelligence technologies, and in particular, to a text verification method and apparatus, a storage medium, and an electronic device.

### BACKGROUND

With rapid development of artificial intelligence, large language models (LLMs) have demonstrated outstanding capabilities in the field of natural language processing, but they still have limitations. For example, LLMs are prone to illusions, and it is necessary to obtain the latest knowledge to avoid these illusions. For example, LLMs can be enhanced through retrieval-augmented generation (RAG) methods, which leverage external knowledge retrieved from a knowledge base to enhance the LLMs.

RAG typically includes three components: a knowledge base, a retriever, and an LLM. The introduction of the knowledge base allows the LLM to obtain the latest knowledge, which provides a more accurate basis for the LLM to generate results, thereby mitigating illusions. However, the introduction of knowledge bases can lead to potential security vulnerabilities.

Knowledge injection attacking is a type of attack against a knowledge base. Attackers can add erroneous texts to the knowledge base through various means, causing the LLM to produce erroneous results when generating answers using these erroneous texts, thus affecting the user experience. The erroneous texts are obtained by the attackers by altering correct texts.

### SUMMARY

This specification provides a text verification technique, which among others, can prevent erroneous texts from being injected into a knowledge base,

This specification of the present application provides a text verification method and apparatus, a storage medium, and an electronic device, which at least partially resolve the technical problems in the existing technology.

The following technical solutions are included in this specification of the present application:

This specification of the present application provides a text verification method, including: obtaining a to-be-verified text set for constructing a knowledge base, the to-be-verified text set including at least two to-be-verified texts; determining a similarity between every two to-be-verified texts in the to-be-verified text set; determining each to-be-detected text pair for performing knowledge conflict detection from the to-be-verified text set based on each similarity; for each to-be-detected text pair, determining a knowledge detection result of the to-be-detected text pair by using a pre-trained knowledge conflict detection model; and in response to that the knowledge detection result indicates that knowledge included in two to-be-detected texts conflicts, obtaining a plurality of original texts of the two to-be-detected texts including the conflicting knowledge through a plurality of search engines, and determining a kept text from the two to-be-detected texts including the conflicting knowledge based on the plurality of original texts; or in response to that the knowledge detection result indicates that knowledge included in two to-be-detected texts does not conflict, determining the two to-be-detected texts as kept texts.

This specification of the present application provides a text verification apparatus, including: a to-be-verified text set acquisition module, configured to obtain a to-be-verified text set for constructing a knowledge base, the to-be-verified text set including at least two to-be-verified texts; a similarity determining module, configured to determine a similarity between every two to-be-verified texts in the to-be-verified text set; a to-be-detected text pair determining module, configured to determine each to-be-detected text pair for performing knowledge conflict detection from the to-be-verified text set based on each similarity; a conflict detection module, configured to: for each to-be-detected text pair, determine a knowledge detection result of the to-be-detected text pair by using a pre-trained knowledge conflict detection model; and a post-processing module, configured to: in response to that the knowledge detection result indicates that knowledge included in two to-be-detected texts conflicts, obtain a plurality of original texts of the two to-be-detected texts including the conflicting knowledge through a plurality of search engines, and determining a kept text from the two to-be-detected texts including the conflicting knowledge based on the plurality of original texts; or in response to that the knowledge detection result indicates that knowledge included in two to-be-detected texts does not conflict, determine the two to-be-detected texts as kept texts.

This specification of the present application provides a computer-readable storage medium. The storage medium stores a computer program, and when the computer program is executed by a processor, the above text verification method is implemented.

This specification of the present application provides an electronic device, including a memory, a processor, and a computer program stored in the memory and running on the processor. When the processor executes the program, the above text verification method is implemented.

The above at least one technical solution used in this specification of the present application can achieve the following beneficial effects:

In the text verification solution provided in this specification of the present application, text representations of two to-be-verified texts may be very similar, and have a very high similarity, but this does not necessarily mean that knowledge points included in the two to-be-verified texts are consistent. Therefore, it can be determined, by using a knowledge conflict detection model, whether knowledge included in the two to-be-detected texts conflicts. However, in response to that the two to-be-detected texts have a high similarity and the knowledge included in the two to-be-detected texts conflicts, there may be erroneous texts. Because attackers cannot modify knowledge in each search engine, multiple original texts of to-be-detected texts are queried through multiple engines, and erroneous texts and kept texts can be determined based on the original texts, preventing the erroneous texts from being stored in a knowledge base.

### BRIEF DESCRIPTION OF DRAWINGS

The accompanying drawings herein are configured for providing a further understanding of this specification of the present application and constitute a part of this specification of the present application. Example implementations of this specification of the present application and the descriptions thereof are intended to explain this specification of the present application, and do not constitute any limitation on this specification of the present application. In the accompanying drawings:

FIG. 1 is a schematic flowchart illustrating a text verification method according to this specification of the present application;

FIG. 2 is a flowchart illustrating relationship extraction according to this specification of the present application;

FIG. 3 is a schematic diagram illustrating a knowledge detection result determining process according to this specification of the present application;

FIG. 4 is another schematic diagram illustrating a knowledge detection result determining process according to this specification of the present application;

FIG. 5 is another flowchart illustrating relationship extraction according to this specification of the present application;

FIG. 6 is a schematic diagram illustrating a similarity determining process according to this specification of the present application;

FIG. 7 is a schematic diagram illustrating a text verification apparatus according to this specification of the present application; and

FIG. 8 is a schematic diagram illustrating an electronic device corresponding to FIG. 1 according to this specification of the present application.

### DESCRIPTION OF IMPLEMENTATIONS

To make the objectives, technical solutions, and advantages of this specification of the present application clearer, the following clearly and completely describes the technical solutions of the present application with reference to example implementations of the present application and corresponding accompanying drawings. Clearly, the described implementations are merely some but not all of implementations of this specification of the present application. Based on implementations of this specification of the present application, all other implementations obtained by a person of ordinary skill in the art without creative efforts fall within the protection scope of the present application.

To better understand and describe the solutions provided in implementations of this disclosure, the following briefly describes some technical terms involved in implementations of this disclosure.

Large language models (LLMs) are trained on large-scale datasets and can understand and generate human language. The LLMs typically have millions to billions of parameters and can perform a variety of natural language processing tasks, such as text generation, question answering, and translation, without requiring additional training in a specific field.

Retrieval-augmented generation (RAG) is a technique for enhancing large language models, enabling the LLMs to effectively process excessively long contextual information. The advantage of using RAG is that it can expand the context of the LLMs, allowing the LLMs to access a large amount of external information without storing all information inside the models. This not only reduces computing resources required for model training, but also enables the LLMs to use the latest information in real time.

Knowledge injection attack is a type of attack targeting LLMs using the RAG. Attackers can add documents including erroneous knowledge to a knowledge base in multiple ways. If the LLMs retrieve these documents during inference, they will generate erroneous answers when generating responses, allowing attackers to compromise the reliability and accuracy of the LLMs.

There are many existing solutions to defend against RAG knowledge injection attacks, such as knowledge expansion methods, which dilute the impact of malicious content and mitigate the attack effect by adding contextual information. The introduction of relevant rich background information enhances the model's understanding capabilities and reduces the significance of malicious content. However, the penetration of malicious content cannot be completely prevented. Attackers can carefully design content that obfuscates the context and can also increase computing resource consumption and processing time. A restatement method involves rewriting a given question using an LLM and then retrieving text from a knowledge database to generate an answer. However, the effect of this method depends on the capability of the LLM and the richness of the knowledge database.

In addition, the existing solutions are all performed in real time during LLM inference, which increases the inference time of the LLM and affects the user experience.

Implementations of this specification of the present application provide a text verification technique. The text verification technique is operated in the knowledge base construction phase, and does not interfere with in the inference phase. Therefore, an inference speed of an LLM model is not affected, and user experience is improved.

An execution body of this specification of the present application can be a computing device(s) or system(s) deployed with an LLM, such as a server, or can be a device such as a desktop computer or a laptop computer. This is not limited in this specification of the present application. For ease of description, the following describes the text verification method provided in this specification of the present application only by using the server as the execution body.

With reference to the accompanying drawings, the following describes in detail the technical solutions provided in implementations of this specification of the present application.

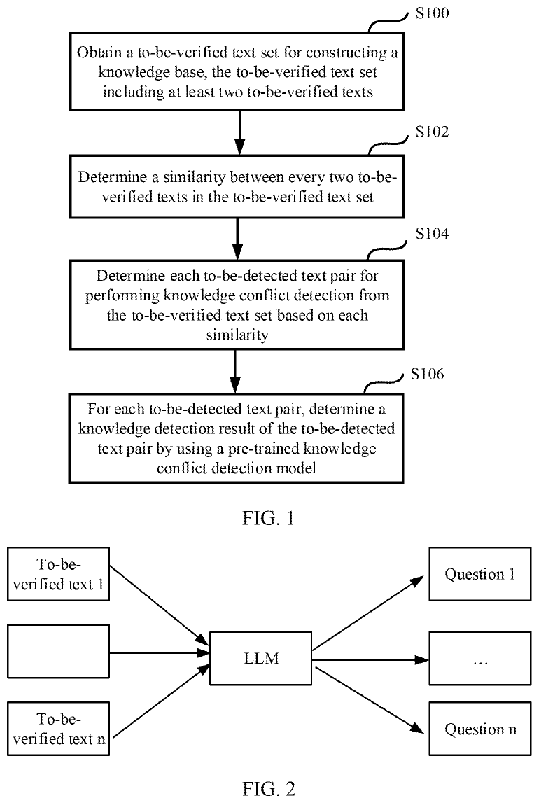

FIG. 1 is a schematic flowchart illustrating a text verification method according to this specification of the present application, which, in some implementations, includes the following steps.

S100: Obtain a to-be-verified text set for constructing a knowledge base, the to-be-verified text set including at least two to-be-verified texts.

In the knowledge base construction phase, to avoid injecting an erroneous text into a knowledge base, the server can perform text verification on each to-be-verified text in the to-be-verified text set for constructing the knowledge base, to determine whether the text subsequently injected into the knowledge base is an erroneous text. The server can obtain the to-be-verified text set for constructing the knowledge base from any one or more data sources, for example, a publicly available internet resource, a digital book, a social media platform, and a professional database. The publicly available internet resource can include a news website, a forum, and the like. The professional database is a database in a specific field, such as clinical trial data in the healthcare industry and case law codes in the legal industry.

The to-be-verified text set includes at least two to-be-verified texts that can be used for subsequent knowledge conflict detection, and in terms of obtaining the to-be-verified texts, obtaining multiple to-be-verified texts at a time can save computing resources, and eliminate the need to make multiple requests to an external data source.

S102: Determine a similarity between every two to-be-verified texts in the to-be-verified text set.

For example, every two to-be-verified texts in the to-be-verified text set can be input into a similarity matching model, to determine the similarity between the every two to-be-verified texts in the to-be-verified text set. Key information of each to-be-verified text in the to-be-verified text set can be further extracted. In some implementations, the similarity between every two to-be-verified texts in the to-be-verified text set is determined based on the key information.

The server can use an LLM to extract multiple questions from a to-be-verified text as key information of the to-be-verified text.

For example, the to-be-verified text is “Xiaoming likes apples but doesn't like bananas”, and the questions extracted by the LLM can be “What fruit does Xiaoming like to eat?” and “What does Xiaoming not like to eat?”.

FIG. 2 is a flowchart illustrating relationship extraction according to this specification of the present application.

If the to-be-verified text set includes n to-be-verified texts, the n to-be-verified texts can be input into the LLM, and the LLM can extract one question for each to-be-verified text to obtain the n questions of the n to-be-verified texts. Certainly, more than one question can be extracted for one to-be-verified text as key information of the to-be-verified text. The number of to-be-verified texts that are input into the LLM at a time is not limited in this specification of the present application.

Comparing key information between to-be-verified texts, such as entities, relationships, and subjects, can capture core meanings of the to-be-verified texts more accurately, thereby avoiding interference from irrelevant words or redundant information. In addition, directly determining each similarity between to-be-verified texts by using key information of the to-be-verified texts can greatly reduce the amount of data that needs to be processed, thereby speeding up the calculation and improving the efficiency of similarity determining. Because the key information is closely related to subjects or main content of the to-be-verified texts, similarity assessment results based on the key information are easier to interpret, e.g., more interpretable.

Certainly, the to-be-verified text or a keyword included in the to-be-verified text can also be directly used as key information. How to extract the key information of each to-be-verified text in the to-be-verified text set is not limited in this specification of the present application. The similarity between every two to-be-verified texts in the to-be-verified text set can also be determined by using another method. This is not limited in this specification of the present application.

S104: Determine each to-be-detected text pair for performing knowledge conflict detection from the to-be-verified text set based on each similarity.

In this specification of the present application, two to-be-verified texts with a similarity greater than a predetermined similarity can be determined as the to-be-detected text pair for performing knowledge conflict detection.

By setting a similarity threshold, text pairs with significant semantic differences can be filtered out, avoiding conflict detection of irrelevant text. This is because if a similarity between two to-be-verified texts is low, it is likely that the two to-be-verified texts describe completely different subjects or things. In this case, because the two to-be-verified texts are not related, it is not determined whether knowledge points of the two to-be-verified texts conflict.

S106: For each to-be-detected text pair, determine a knowledge detection result of the to-be-detected text pair by using a pre-trained knowledge conflict detection model.

The most prominent characteristic of an erroneous text is that it is very similar to an original text in terms of representation, but knowledge points described in the erroneous text and the original text are completely different. Therefore, through knowledge conflict detection, it can be determined whether the to-be-detected text in the to-be-detected text pair is an erroneous text.

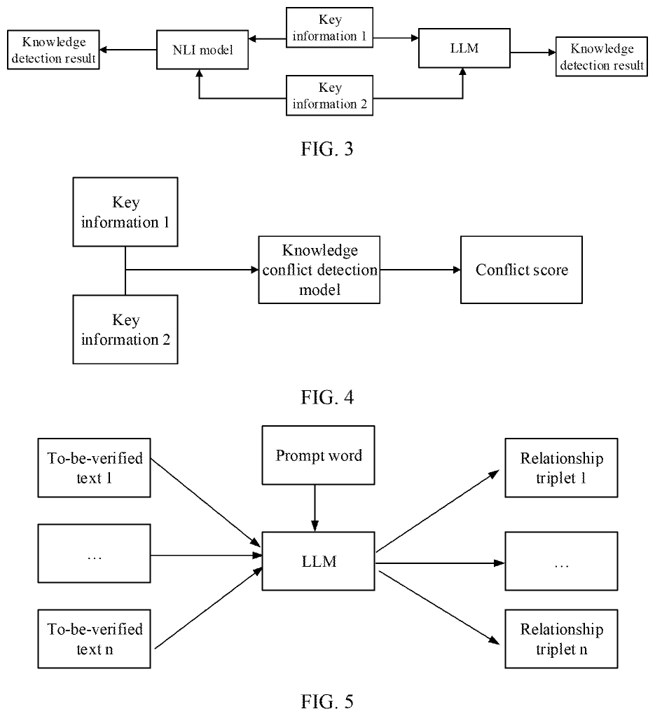

FIG. 3 is a schematic diagram illustrating a knowledge detection result determining process according to this specification of the present application.

If key information of the to-be-detected text pair is key information 1 and key information 2, the key information 1 and the key information 2 can be input into the knowledge conflict detection model, to obtain an output result of the knowledge conflict detection model as a knowledge detection result of the to-be-detected text in the to-be-detected text pair. The knowledge conflict detection model can be a conflict detection large language model, or can be a binary classification model. For example, the binary classification model can be a natural language inference (Natural Language Inference, NLI) model.

When the knowledge conflict detection model is a binary classification model, key information of each to-be-detected text pair is obtained, and key information of each to-be-detected text pair is input into the binary classification model, to obtain a knowledge detection result output by the binary classification model.

The natural language inference model is a model that can be used to determine a logical relationship between two texts, e.g., involving three categories: implication, contradiction, and neutrality. The NLI model can determine the logical relationship between the two texts by analyzing a relationship between the premise and the hypothesis. The premise can be either of the two texts, and the other text is the hypothesis. It can be determined whether the hypothesis is true based on the premise.

For example, if the premise is that Xiaoming only likes apples, and the hypothesis is that Xiaoming likes bananas, it is determined that the hypothesis is not true based on the premise, and the output result is the contradiction.

In this specification of the present application, when the NLI model is trained, the NLI model only needs to output a binary classification result, e.g., yes or no. If the result output by the NLI model is “yes”, it indicates that there is a knowledge conflict between the two texts. If the result output by the NLI model is “no”, it indicates that there is no knowledge conflict between the two texts.

Conflict detection performed by using the NLI model can automatically analyze the logical relationship of the text pair, so that conflict detection efficiency can be improved without manual check. The NLI model can also identify subtle linguistic differences and potential knowledge conflicts, rather than just superficial word-for-word comparisons. Therefore, conflict detection performed by using the NLI model is more accurate.

The knowledge conflict detection model can alternatively be a conflict detection large language model. When the knowledge conflict detection model is a conflict detection large language model, a conflict prompt word is obtained, and the conflict prompt word and the to-be-detected text in each to-be-detected text pair are input into the conflict detection large language model, to obtain a knowledge detection result output by the conflict detection large language model.

When the conflict detection large language model is used as the knowledge conflict detection model, the conflict prompt word can be a field or a keyword that may conflict with the text in the to-be-detected text pair, helping the conflict detection large language model to better focus on a knowledge point that may be in conflict.

For example, two to-be-detected texts in the to-be-detected text pair are respectively: “Xiaoming likes apples.” and “Xiaoming doesn't like any fruit.” Conflict prompt words can be “like”, “doesn't like”, and “fruit”. The conflict detection large language model can, in some implementations, check the contradiction between these keywords.

In addition, using the conflict detection large language model as the knowledge conflict detection model allows the conflict detection large language model to focus on a conflict prompt word, eliminating the need for comprehensive analysis of the entire text and instead focusing on potentially problematic parts, thereby improving detection efficiency.

FIG. 4 is another schematic diagram illustrating a knowledge detection result determining process according to this specification of the present application.

The knowledge conflict detection model can further output a conflict score between the two to-be-detected texts in the to-be-detected text pair, and determine, based on the conflict score, whether knowledge included in the two to-be-detected texts in the to-be-detected text pair conflicts. For example, it can be set that if the conflict score is greater than a predetermined score, the knowledge included in the two to-be-detected texts conflicts; or if the conflict score is not greater than the predetermined score, the knowledge included in the two to-be-detected texts does not conflict.

It is worthwhile to note that when the knowledge detection result indicates that the knowledge included in the two to-be-detected texts does not conflict, the two to-be-detected texts are determined as texts that are to be kept, each referred to as a “kept text”. When the knowledge detection result indicates that the knowledge included in the two to-be-detected texts conflicts, the server can determine, based on records of obtaining to-be-verified texts, other to-be-verified texts obtained at the same time as the two to-be-detected texts, and determine whether a knowledge conflict also exists between the other to-be-verified texts. If there is a knowledge conflict between to-be-verified texts that exceed a predetermined first threshold, it indicates that quality of the to-be-verified texts obtained in this batch is poor, and most of the to-be-verified texts can be erroneous texts. Therefore, the two to-be-detected texts and the other to-be-verified texts obtained at the same time as the two to-be-detected texts can be deleted, thereby reducing a risk of injecting the erroneous texts into the knowledge base. For example, all the to-be-detected texts in this batch are deleted. Batches are distinguished by time, and to-be-detected texts obtained at the same time belong to a same batch.

Based on the text verification method shown in FIG. 1, text representations of two to-be-verified texts may be very similar, and have a very high similarity, but this does not necessarily mean that knowledge points included in the two to-be-verified texts are consistent. Therefore, it can be determined, by using a knowledge conflict detection model, whether knowledge included in the two to-be-detected texts conflicts. However, when the two to-be-detected texts have a high similarity and the knowledge included in the two to-be-detected texts conflicts, there may be erroneous texts. Because attackers cannot modify knowledge in each search engine, multiple original texts of to-be-verified texts are queried through multiple engines, and erroneous texts and kept texts can be determined based on the original texts, preventing the erroneous texts from being stored in a knowledge base.

For step S102, the goal of key information extraction is to obtain a key information representation of each to-be-verified text in the knowledge base. For example, a relationship triplet of each to-be-verified text in the to-be-verified text set can be extracted by using a predetermined relationship extraction method, and the relationship triplet is determined as the key information of the to-be-verified text. A relationship triplet is a triplet that includes a subject, an object, and a relationship between the subject and the object. The subject is a start entity in the relationship, and is generally an executor of an action or a main object of a statement. The object is a target entity in the relationship, and is generally affected by an action of the subject or is associated with the subject. The relationship is used to describe a specific relationship between the subject and the object.

For example, the to-be-verified text is “Xiaoming likes apples but doesn't like bananas.” Relationship triplets that can be extracted are: <Xiaoming, likes, apples>, <Xiaoming, doesn't like, bananas>.

The predetermined relationship extraction method can include any one of the following:

Relationship extraction is performed by using a pre-trained relationship extraction model.

The LLM is used as a relationship extractor, so that the LLM completes a relationship extraction task based on a predetermined prompt word. The prompt word can be a relationship triplet in an extracted text, and how to extract a relationship triplet of each to-be-verified text in the to-be-verified text set is not limited in this specification of the present application.

FIG. 5 is another flowchart illustrating relationship extraction according to this specification of the present application.

If the to-be-verified text set includes n to-be-verified texts, the n to-be-verified texts can be input into the LLM to obtain n relationship triplets of the n to-be-verified texts. Certainly, more than one relationship triplet can also be extracted for one to-be-verified text.

The relationship triplet directly reflects a relationship between entities, which can better reflect a real meaning of the to-be-verified text, and further provides structured semantic information. Using the relationship triplet as the key information improves accuracy of similarity calculation.

When determining the similarity between every two to-be-verified texts in the to-be-verified text set, the server can input the key information of each to-be-verified text in the to-be-verified text set into an embedded model to obtain a feature vector of each to-be-verified text that is output by the embedded model; and determine the similarity between every two to-be-verified texts by using a predetermined similarity determining method based on the feature vectors of every two to-be-verified texts in the to-be-verified text set.

The predetermined similarity determining method can include any one of cosine similarity, European distance, Manhattan distance, and Pearson correlation coefficient.

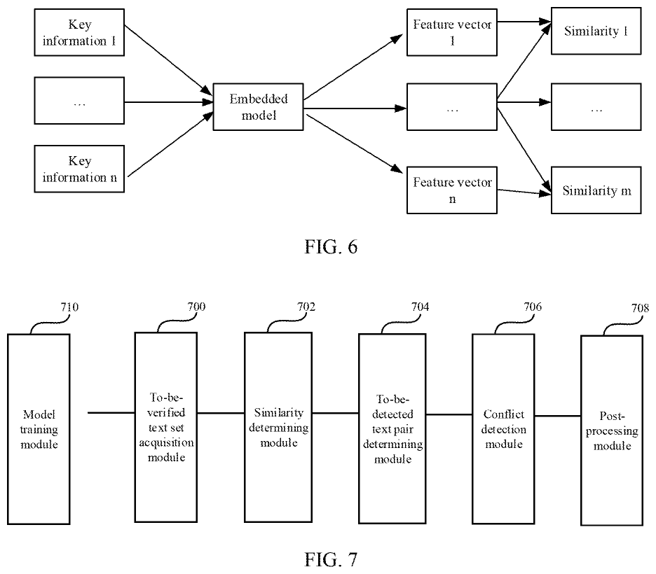

FIG. 6 is a schematic diagram illustrating a similarity determining process according to this specification of the present application. A correspondence between a part of feature vectors and a similarity is not shown, and m is

$$\frac{n ( n - 1 )}{2} .$$

The server can input key information 1 to key information n into the embedded model to obtain n feature vectors output by the embedded model, then determine a similarity between every two feature vectors, and obtain m similarities by using the predetermined similarity determining method, to obtain m similarities, e.g., obtain a similarity between every two to-be-verified texts in the to-be-verified text set.

For step S104, the server can further aggregate each feature vector based on each similarity by using a predetermined similarity aggregation method to obtain a similar group, and determine a to-be-verified text corresponding to each feature vector in the similar group as a to-be-detected text. The predetermined similarity aggregation method can be a community detection algorithm, such as a Louvain algorithm.

For example, the feature vector of each to-be-verified text can be considered as a node in a node network graph, and a similarity between nodes is used as a weight of an edge. Then, each node, as a community, traverses all nodes and calculates a modularity gain brought by moving a current node to an adjacent community. The modularity gain is as follows:

$$ΔQ = \frac{\sum IN + 2 {K}_{I , IN}}{2 m} - ( \frac{\sum tot + {K}_{I}}{2 m} )$$

ΣIN is a sum of edge weights inside a community, K_{I,IN} is a connection weight between a node and a target community, Σtot is a total edge weight of a community, K_{I} is a total edge weight of a node, and m is a total edge weight of a node network.

Next, the node is moved to a community that maximizes the positive modularity gain, and if there is no such community, the original community is maintained. All nodes in a same community are combined into a new node, and inter-new-node edge weight is a sum of all inter-original-community edge weights, forming a new node network graph. All the nodes are traversed again, and the modularity gain brought by moving the current node to the adjacent community is calculated, until modularity is no longer raised to obtain a final community. The community is a similar group, and feature vectors in each similar group have a high similarity, and a to-be-verified text corresponding to the feature vector in the similar group is determined as a to-be-detected text.

The similar group is obtained by performing aggregation by using the similarity. Subsequently, conflict detection can be performed on to-be-detected text in a same similar group, eliminating the need to perform conflict detection on texts belonging to different similarity groups. This greatly reduces computing resource consumption and improves the efficiency of conflict detection.

For step S106, when the knowledge detection result indicates that knowledge included in two to-be-detected texts conflicts, a plurality of original texts of the two to-be-detected texts including the conflicting knowledge are obtained through a plurality of search engines, and a kept text is determined from the two to-be-detected texts including the conflicting knowledge based on the plurality of original texts.

When the original text is determined, preliminary screening can be first performed based on the similarity, e.g., a first text whose similarity to the to-be-detected text exceeds a predetermined second threshold is obtained. Then, a source authority evaluation is performed on the first text, and a text with higher source authority is selected as a second text. A source has a predetermined level, and a higher level indicates higher authority. For example, a level of a self-media forum can be set to a low level, and a level of a school official network can be set to a medium level. The first text whose level is at least a medium level can be selected as the second text. Finally, by comparing release time, a third text whose release time is earlier than release time of the to-be-detected text can be obtained as the original text.

When the knowledge detection result indicates that the knowledge included in the two to-be-detected texts conflicts, the original texts obtained through the plurality of search engines are used to determine the kept text. This is because attackers cannot modify the knowledge in each search engine. Therefore, multiple original texts of multiple engines are cross-verified to determine the kept text, which has strong resistance to attacks and prevents erroneous texts from being stored in the knowledge base. In addition, with reference to a similar text detection function of the search engine, altered content of the erroneous text can be identified, which further improves accuracy of the determined kept text.

For example, for each to-be-detected text including the conflicting knowledge, the server can determine the to-be-detected text and an original knowledge detection result of each original text of the to-be-detected text; and when a number of target knowledge detection results in each original knowledge detection result is greater than a predetermined quantity, determine the to-be-detected text as the kept text, the target knowledge detection result being that knowledge included in the to-be-detected text does not conflict with knowledge in the original text of the to-be-detected text.

For example, for to-be-detected text 1, four original texts of the to-be-detected text 1 are obtained through a plurality of search engines, and knowledge detection results of the four original texts and the to-be-detected text 1 are separately determined by using the knowledge conflict detection model. When three of the knowledge detection results are that knowledge included in the to-be-detected text does not conflict with knowledge in the original texts of the to-be-detected text, the to-be-detected text is determined as the original text.

This specification of the present application further provides a model training method. An execution body can be a computing device that can be used for model training. For ease of description, the execution body is used as a server for description. When a knowledge conflict detection model is a binary classification model, the server can train the knowledge conflict detection model.

For example, the server can obtain a plurality of sample text pairs and a detection result of each sample text pair, the sample text pair including one or more of a standard text or an altered text; obtain key information of each sample text in each sample text pair; input the key information of each sample text in each sample text pair into the knowledge conflict detection model to obtain a prediction result of the sample text pair that is output by the knowledge conflict detection model; and train the knowledge conflict detection model based on the prediction result and the detection result.

It is worthwhile to note that the detection result of each sample text pair includes whether knowledge included in two sample texts in the sample text pair conflicts or not. The standard text is unaltered text and can be considered as a sample original text. The altered text can be obtained by making erroneous changes to the standard text. For example, the standard text is “Xiaoming only likes apples”, and the altered text can be “Xiaoming only likes grapes”.

Different from methods in the existing technology, the method in this specification of the present application is operated in the knowledge base construction phase, and is not interfered with in the inference phase. Therefore, a system inference speed is not affected when the service is online. Compared with a knowledge expansion method, the method in this specification of the present application does not impose any limitation on a number of retrieved texts during inference. However, the knowledge expansion method requires a large number of texts to be detected to dilute toxic texts. Therefore, the method in this specification of the present application is more flexible in terms of computing resource consumption and super-parameter setting. Compared with a restatement method, the method in this specification of the present application does not require additional calls to the LLM for restatement tasks during inference, resulting in a faster response speed and less impact on a final result generated by the LLM.

The text verification method provided in one or more implementations of this specification of the present application is described above. Based on a same idea, this specification of the present application further provides a corresponding text verification apparatus. As shown in FIG. 7, the apparatus includes: a to-be-verified text set acquisition module 700, configured to obtain a to-be-verified text set for constructing a knowledge base, the to-be-verified text set including at least two to-be-verified texts; a similarity determining module 702, configured to determine a similarity between every two to-be-verified texts in the to-be-verified text set; a to-be-detected text pair determining module 704, configured to determine each to-be-detected text pair for performing knowledge conflict detection from the to-be-verified text set based on each similarity; a conflict detection module 706, configured to: for each to-be-detected text pair, determine a knowledge detection result of the to-be-detected text pair by using a pre-trained knowledge conflict detection model; and a post-processing module 708, configured to: when the knowledge detection result indicates that knowledge included in two to-be-detected texts conflicts, obtain a plurality of original texts of the two to-be-detected texts including the conflicting knowledge through a plurality of search engines, and determining a kept text from the two to-be-detected texts including the conflicting knowledge based on the plurality of original texts; or when the knowledge detection result indicates that knowledge included in two to-be-detected texts does not conflict, determine the two to-be-detected texts as kept texts.

In some implementations, the similarity determining module 702 is configured to extract key information of each to-be-verified text in the to-be-verified text set; and determine the similarity between every two to-be-verified texts in the to-be-verified text set based on the key information.

In some implementations, the similarity determining module 702 is configured to extract a relationship triplet of each to-be-verified text in the to-be-verified text set by using a predetermined relationship extraction method; and determine the relationship triplet as the key information of the to-be-verified text.

In some implementations, the similarity determining module 702 is configured to input the key information of each to-be-verified text in the to-be-verified text set into an embedded model to obtain a feature vector of each to-be-verified text that is output by the embedded model; and determine the similarity between every two to-be-verified texts by using a predetermined similarity determining method based on the feature vectors of every two to-be-verified texts in the to-be-verified text set.

In some implementations, the to-be-detected text pair determining module 704 is configured to aggregate each feature vector based on each similarity by using a predetermined similarity aggregation method to obtain a similar group; and determine a to-be-verified text corresponding to each feature vector in the similar group as a to-be-detected text.

In some implementations, the conflict detection module 706 is configured to: when the knowledge conflict detection model is a conflict detection large language model, obtain a conflict prompt word, and input the conflict prompt word and the to-be-detected text in each to-be-detected text pair into the conflict detection large language model, to obtain a knowledge detection result output by the conflict detection large language model; and when the knowledge conflict detection model is a binary classification model, obtain key information of each to-be-detected text pair, and input key information of each to-be-detected text pair into the binary classification model, to obtain a knowledge detection result output by the binary classification model.

In some implementations, the post-processing module 708 is configured to: for each to-be-detected text including the conflicting knowledge, determine the to-be-detected text and an original knowledge detection result of each original text of the to-be-detected text; and when the number of target knowledge detection results in each original knowledge detection result is greater than a predetermined quantity, determine the to-be-detected text as the kept text, the target knowledge detection result being that knowledge included in the to-be-detected text does not conflict with knowledge in the original text of the to-be-detected text.

In some implementations, the apparatus further includes: a model training module 710, configured to: when the knowledge conflict detection model is a binary classification model, obtain a plurality of sample text pairs and a detection result of each sample text pair, the sample text pair including one or more of a standard text or an altered text; obtain key information of each sample text in each sample text pair; input the key information of each sample text in each sample text pair into the knowledge conflict detection model to obtain a prediction result of the sample text pair that is output by the knowledge conflict detection model; and train the knowledge conflict detection model based on the prediction result and the detection result.

This specification of the present application further provides a computer-readable storage medium. The storage medium stores a computer program, and the computer program can be configured to perform the text verification method provided in FIG. 1.

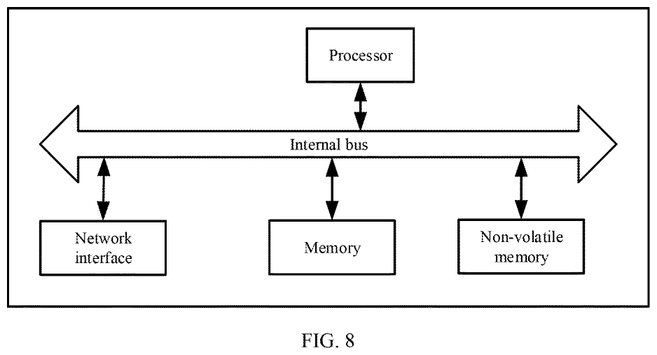

This specification of the present application further provides a schematic diagram illustrating a structure of the electronic device shown in FIG. 8. As shown in FIG. 8, at a hardware level, the electronic device includes a processor, an internal bus, a network interface, a memory, and a non-volatile memory, and certainly can further include hardware required by another service. The processor reads a corresponding computer program from the non-volatile memory and runs the program in the memory, so as to implement the text verification method in FIG. 1. Certainly, in addition to a software implementation, this specification of the present application does not exclude another implementation, such as a logic component or a combination of software and hardware, e.g., an execution body of the following processing procedure is not limited to each logical unit, and can be hardware or a logical component.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application specific integrated circuit chip. In addition, at present, instead of manually manufacturing an integrated circuit chip, this type of programming is mostly implemented by using “logic compiler” software. The software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the above-mentioned a plurality of hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller can be considered as a hardware component, and an apparatus included in the controller for implementing various functions can also be considered as a structure in the hardware component. Alternatively, the apparatus configured to implement various functions can even be considered as both a software module implementing the method and a structure in the hardware component.

Systems, apparatuses, modules, or units that are described in the above-mentioned implementations can be for example implemented by using a computer chip or an entity, or by using a product with a certain function. A typical implementation device is a computer. For example, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the above apparatus is described by dividing functions into various units. Certainly, during implementation of this specification of the present application, functions of units can be implemented in the same or more pieces of software and/or hardware.

A person skilled in the art should understand that implementations of the present application can be provided as a method, a system, or a computer program product. Therefore, the present invention can use a form of hardware only implementations, software only implementations, or implementations with a combination of software and hardware. In addition, the present invention can use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the implementations of the present invention. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a function in one or more processes in the flowcharts and/or in one or more blocks in the block diagrams.

Alternatively, these computer program instructions can be stored in a computer-readable storage that can instruct a computer or another programmable data processing device to work in a manner, so the instructions stored in the computer-readable storage generate an artifact that includes an instruction apparatus. The instruction apparatus implements a function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a function in one or more procedures in the flowcharts and/or in one or more blocks in the block diagrams.

In a typical configuration, the computer includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The memory can include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device or any other non-transmission media that can be configured to store information that a computing device can access. As described in the present specification, the computer-readable medium does not include transitory computer-readable media (transitory media) such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes one . . . ” does not exclude the existence of additional identical elements in the process, method, product, or device that includes the element.

A person skilled in the art should understand that implementations of this specification of the present application can be provided as a method, a system, or a computer program product. Therefore, this specification of the present application can use a form of hardware only implementations, software only implementations, or implementations with a combination of software and hardware. In addition, this specification of the present invention can use a form of a computer program product that is implemented on one or more computer-usable storage media (including but not limited to a disk memory, a CD-ROM, an optical memory, and the like) that include computer-usable program code.

This specification of the present application can be described in general contexts of computer-executable instructions executed by computers, for example, program modules. Typically, the program modules include routines, programs, objects, components, data structures, and the like that perform tasks or implement abstract data types. This specification of the present application can also be practiced in distributed computing environments in which tasks are executed by remote processing devices connected by using communication networks. In the distributed computing environments, the program modules can be located in local and remote computer storage media including storage devices.

Implementations in this specification of the present application are described in a progressive manner. For same or similar parts in implementations, reference can be made to each other. Each implementation focuses on a difference from other implementations. Particularly, the system implementations are basically similar to the method implementations, and therefore are described briefly. For related parts, references can be made to some descriptions of the method implementations.

In summary, the above descriptions are merely implementations of this specification of the present application, and are not intended to limit this specification of the present application. For a person skilled in the art, various changes and changes can be made in this specification of the present application. Any modification, equivalent replacement, or improvement made in the spirit and principle of this specification of the present application shall fall within the scope of the claims of the present application.

1. A text verification method, comprising:
obtaining a plurality of to-be-verified texts;
determining a similarity between to-be-verified texts of the plurality of to-be-verified texts;
determining a pair of two to-be-verified texts from the plurality of to-be-verified texts based on a similarity between the two to-be-verified texts;
determining a knowledge detection result of the two to-be-verified texts of the pair by using a knowledge conflict detection model;
in response to that the knowledge detection result indicates that knowledge included in the two to-be-verified texts conflicts, obtaining a plurality of original texts of the two to-be-verified texts, and determining a kept text from the two to-be-verified texts based on the plurality of original texts; and
in response to that the knowledge detection result indicates that knowledge included in the two to-be-verified texts does not conflict, determining the two to-be-verified texts as kept texts.

2. The method according to claim 1, wherein the determining the similarity between to-be-verified texts in the plurality of to-be-verified texts includes:
extracting key information of a to-be-verified text of the plurality of to-be-verified texts; and
determining a similarity between every two to-be-verified texts of the plurality of to-be-verified texts based on the key information.

3. The method according to claim 2, wherein the extracting the key information of the to-be-verified text includes:
extracting a relationship triplet of the to-be-verified text; and
determining the relationship triplet as the key information of the to-be-verified text.

4. The method according to claim 2, wherein the determining the similarity between every two to-be-verified texts of the plurality of to-be-verified texts based on the key information includes:
inputting the key information of each to-be-verified text of the plurality of to-be-verified texts into an embedded model to obtain a feature vector of each to-be-verified text; and
determining the similarity between every two to-be-verified texts based on the feature vectors of the every two to-be-verified texts of the plurality of to-be-verified texts.

5. The method according to claim 4, wherein the determining the pair of two to-be-verified texts includes:
aggregating the feature vector of each to-be-verified text based on the similarity between every two to-be-verified texts to obtain a similar group; and
determining a to-be-verified text corresponding to a feature vector in the similar group as a to-be-verified text of the pair.

6. The method according to claim 1, wherein the determining the knowledge detection result of the two to-be-verified texts of the pair comprises:
obtaining a conflict prompt word, and inputting the conflict prompt word and a to-be-verified text of the two to-be-verified text of the pair into a conflict detection large language model, to obtain a knowledge detection result.

7. The method according to claim 1, wherein the determining the knowledge detection result of the two to-be-detected texts of the pair comprises:
obtaining key information of the two to-be-verified texts of the pair, and
inputting the key information of the two to-be-verified texts of the pair into a binary classification model to obtain a knowledge detection result.

8. The method according to claim 1, wherein the determining the kept text from the two to-be-verified texts based on the plurality of original texts includes:
for each to-be-verified text including the conflicting knowledge, determining an original knowledge detection result between the to-be-verified text and an original text of the to-be-verified text; and
in response to that a number of target knowledge detection results in the original knowledge detection result is greater than a threshold quantity, determining the to-be-verified text as a kept text, a target knowledge detection result being that knowledge included in the to-be-verified text does not conflict with knowledge in the original text of the to-be-verified text.

9. The method according to claim 1, wherein the knowledge conflict detection model is a binary classification model, and
the method further comprises training the knowledge conflict detection model, including:
obtaining a plurality of sample text pairs of sample texts and a detection result of each sample text pair, a sample text pair including one or more of a standard text or an altered text;
obtaining key information of each sample text in each sample text pair;
inputting the key information of each sample text in each sample text pair into the knowledge conflict detection model to obtain a prediction result of the sample text pair; and
training the knowledge conflict detection model based on the prediction result and the detection result.

10. An electronic device, comprising one or more processors and one or more memories, individually or collectively, having computer executable instructions stored thereon, the computer executable instructions, when executed by the one or more processors, enabling the one or more processors to, individually or collectively, implement acts including:
obtaining a plurality of to-be-verified texts;
determining a similarity between to-be-verified texts of the plurality of to-be-verified texts;
determining a pair of two to-be-verified texts from the plurality of to-be-verified texts based on a similarity between the two to-be-verified texts;
determining a knowledge detection result of the two to-be-verified texts of the pair by using a knowledge conflict detection model;
in response to that the knowledge detection result indicates that knowledge included in the two to-be-verified texts conflicts, obtaining a plurality of original texts of the two to-be-verified texts, and determining a kept text from the two to-be-verified texts based on the plurality of original texts; and
in response to that the knowledge detection result indicates that knowledge included in the two to-be-verified texts does not conflict, determining the two to-be-verified texts as kept texts.

11. The electronic device according to claim 10, wherein the determining the similarity between to-be-verified texts in the plurality of to-be-verified texts includes:
extracting key information of a to-be-verified text of the plurality of to-be-verified texts; and
determining a similarity between every two to-be-verified texts of the plurality of to-be-verified texts based on the key information.

12. The electronic device according to claim 11, wherein the extracting the key information of the to-be-verified text includes:
extracting a relationship triplet of the to-be-verified text; and
determining the relationship triplet as the key information of the to-be-verified text.

13. The electronic device according to claim 11, wherein the determining the similarity between every two to-be-verified texts of the plurality of to-be-verified texts based on the key information includes:
inputting the key information of each to-be-verified text of the plurality of to-be-verified texts into an embedded model to obtain a feature vector of each to-be-verified text; and
determining the similarity between every two to-be-verified texts based on the feature vectors of the every two to-be-verified texts of the plurality of to-be-verified texts.

14. The electronic device method according to claim 13, wherein the determining the pair of two to-be-verified texts includes:
aggregating the feature vector of each to-be-verified text based on the similarity between every two to-be-verified texts to obtain a similar group; and
determining a to-be-verified text corresponding to a feature vector in the similar group as a to-be-verified text of the pair.

15. The electronic device according to claim 10, wherein the determining the knowledge detection result of the two to-be-verified texts of the pair comprises:
obtaining a conflict prompt word, and inputting the conflict prompt word and a to-be-verified text of the two to-be-verified text of the pair into a conflict detection large language model, to obtain a knowledge detection result.

16. The electronic device according to claim 10, wherein the determining the knowledge detection result of the two to-be-detected texts of the pair comprises:
obtaining key information of the two to-be-verified texts of the pair, and
inputting the key information of the two to-be-verified texts of the pair into a binary classification model to obtain a knowledge detection result.

17. The electronic device according to claim 10, wherein the determining the kept text from the two to-be-verified texts based on the plurality of original texts includes:
for each to-be-verified text including the conflicting knowledge, determining an original knowledge detection result between the to-be-verified text and an original text of the to-be-verified text; and
in response to that a number of target knowledge detection results in the original knowledge detection result is greater than a threshold quantity, determining the to-be-verified text as a kept text, a target knowledge detection result being that knowledge included in the to-be-verified text does not conflict with knowledge in the original text of the to-be-verified text.

18. The electronic device according to claim 10, wherein the knowledge conflict detection model is a binary classification model, and
the acts further include training the knowledge conflict detection model, including:
obtaining a plurality of sample text pairs of sample texts and a detection result of each sample text pair, a sample text pair including one or more of a standard text or an altered text;
obtaining key information of each sample text in each sample text pair;
inputting the key information of each sample text in each sample text pair into the knowledge conflict detection model to obtain a prediction result of the sample text pair; and
training the knowledge conflict detection model based on the prediction result and the detection result.

19. A computer-readable storage medium, wherein the storage medium stores a computer program, and when the computer program is executed by one or more processors, the one or more processors are enable to, individually or collectively, implement acts comprising:
obtaining a plurality of to-be-verified texts;
determining a similarity between to-be-verified texts of the plurality of to-be-verified texts;
determining a pair of two to-be-verified texts from the plurality of to-be-verified texts based on a similarity between the two to-be-verified texts;
determining a knowledge detection result of the two to-be-verified texts of the pair by using a knowledge conflict detection model;
in response to that the knowledge detection result indicates that knowledge included in the two to-be-verified texts conflicts, obtaining a plurality of original texts of the two to-be-verified texts, and determining a kept text from the two to-be-verified texts based on the plurality of original texts; and
in response to that the knowledge detection result indicates that knowledge included in the two to-be-verified texts does not conflict, determining the two to-be-verified texts as kept texts.

20. The computer-readable storage medium according to claim 19, wherein the determining the similarity between to-be-verified texts in the plurality of to-be-verified texts includes:
extracting key information of a to-be-verified text of the plurality of to-be-verified texts; and
determining a similarity between every two to-be-verified texts of the plurality of to-be-verified texts based on the key information.
